(19) United States
(12) Patent Application Publication
(10) Pub. No.: US 2011/0128090 A1
(43) Pub. Date: Jun. 2, 2011

(54) STRIPLINE

(76) Inventors: Kazuyuki Sakiyama, Osaka (JP); Akira Minegishi, Osaka (JP)

(21) Appl. No.: 13/057,085

(22) PCT Filed: May 27, 2010
(86) PCT No.: PCT/JP2010/003546

§ 371 Date: Feb. 1, 2011

(30) Foreign Application Priority Data
Jun. 2, 2009 (JP) 2009-132827

(51) Int. Cl. H01P 5/02; H01P 3/08

(52) U.S. Cl. 333/33; 333/246

(57) ABSTRACT

A strip conductor is provided on a dielectric board, and a ground conductor facing the strip conductor in a thickness direction of the dielectric board is provided on a surface of the dielectric board. The ground conductor is provided with a plurality of holes penetrating therethrough along the thickness direction of the dielectric board. This structure accomplishes a microstrip line that can obtain consistent passing frequency characteristics.

### FIELD OF THE INVENTION

The present invention relates to strip line through which a digital signal is transmitted, comprising a signal waveform matching apparatus configured to substantially equalize passing frequency characteristics in a broad band to match the waveforms of digital signals.

### BACKGROUND OF THE INVENTION

FIG. 7A is a plan view illustrating a structure of a strip line according to a prior art 1. FIG. 7B is a longitudinal sectional view of the strip line illustrated in FIG. 7A cut along D-D′. FIG. 8 is a perspective view of the strip line illustrated in FIGS. 7A-7B.

As illustrated in FIGS. 7A-7B and 8, a microstrip line (comprising a strip conductor 110 and a ground conductor 120 with a dielectric board 100 interposed therebetween) is conventionally used to transmit a digital signal on a printed circuit board. There are different kinds of transmission lines that can be characterized as a strip line, for example, single-end signal transmission line, differential signal transmission line, and coplanar line. These transmission lines share a common feature; it is the shape of the line or board which decides an intrinsic impedance as far as the line or board is made of the same material. Effectively using the common feature, the intrinsic impedance, which is a signal transmission characteristic, can be constant all the time.

In the case of designing a wiring layout on a printed circuit board using the microstrip line, it is often necessary to employ a few design approaches, for example, change of a line width at an intermediate position, and partial omission of a ground conductor.

These designing approaches, however, result in discontinuity in the shape of the strip line, which makes the intrinsic impedance variable in the transmission line. A degree of fluctuation in the intrinsic impedance depends on frequency, therefore, the intrinsic impedance fluctuation deteriorates the waveform of a transmitted signal.

There is a known designing process wherein the intrinsic impedance fluctuation is minimized so that the signal deterioration is controlled (for example, see the Patent Document 1). The designing process wherein the signal deterioration is thus controlled is called a second prior art. FIG. 9A is a transverse sectional view of a strip line according to the second prior art. FIG. 9B is a longitudinal sectional view of the illustration in FIG. 9A cut along A-A. FIG. 9C is a longitudinal sectional view of the illustration in FIG. 9A cut along B-B′. FIG. 9D is a longitudinal sectional view of the illustration in FIG. 9A cut along C-C′. Hereinafter, the second prior art (strip line designing process wherein the signal line width changes at an intermediate position) is described referring to FIGS. 9A-9D.

In the second prior art wherein a microstrip line comprises a strip conductor 110 and a ground conductor 120 with a dielectric board 140 interposed therebetween, a distance between the strip conductor 110 and the ground conductor 120 changes at a position where the width of the strip conductor 110 changes (sectional view B-B′, sectional view C-C′). In the structure where the strip conductor 110 and the ground conductor 120 are thus differently spaced from each other, a capacitance component changes, thereby controlling fluctuation of the intrinsic impedance of the transmission line. In FIGS. 9A-9D, a reference numeral 130 denotes an electric insulation section, and a reference numeral 121 denotes a projection formed on the ground conductor 120.

To prevent the waveform from deteriorating, a designing process is conventionally adopted, wherein through-type vias of a multilayered board are used to control the intrinsic impedance (for example, see the Patent Document 2). The conventional process wherein the signal deterioration is thus controlled is called a third prior art. FIG. 10 is a perspective view of the strip line according to the third prior art. Referring to FIG. 10, the third prior art (designing process wherein through-type vias of a multilayered board are used to control the intrinsic impedance) is described.

In the third prior art, a ground conductor 203 is placed between stripe lines 204 with a dielectric board 201 interposed therebetween, and a dielectric board 201 is placed between the strip lines 204 and the ground conductor 203. Then, vias 202 which connect the strip lines 204 are provided on the dielectric board 201, and clearances 206 which the vias 202 penetrate through are provided on the ground conductor 203. In the third prior art thus structurally characterized, the diameters of the clearances 206 are regulated so that the intrinsic impedance of the transmission line can be set to any intended value. In FIG. 10, a reference numeral 205 denotes a land which connect the strip lines 204 with the via 202.

However, the first-third prior arts are not applicable to the strip line having a discontinuity structure illustrated in FIGS. 11A-11D and 12. FIG. 11A is a front view of a microstrip line having the discontinuity structure, and FIG. 11B is a plan view of the microstrip line, FIG. 11C is a longitudinal sectional view of the microstrip line cut along E-E′, FIG. 11D is a side view of the microstrip line, and FIG. 12 is a perspective view of the microstrip line.

The strip line illustrated in FIGS. 11A-11D and 12 has a discontinuity structure wherein a ground conductor 11 is only provided in a limited area. In any part of the structure where the ground conductor 11 is missing, the capacitance component is not formed between the strip conductor 12 and the ground conductor 11. Therefore, the second and third prior arts fail to control fluctuation of the intrinsic impedance of the microstrip line.

In a conventional designing process for controlling the characteristics of the transmission line, the theory of high-frequency metamaterial is used (see the Non-Patent Document 1). The designing process is called a fourth prior art. FIG. 13 is a circuit diagram of an equivalent circuit as a transmission line model based on a design theory employed in the fourth prior art (concept of high-frequency materials). Referring to FIG. 13, the outline of the fourth prior art is described.

In any conventional strip lines, an equivalent circuit has a ladder shape illustrated in FIG. 13 including inductors L1 and capacitors C1. The fourth prior art further provides inductors L2 and capacitors C2 to the transmission line to exert electric characteristics different to the conventional transmission lines, so that an expected intrinsic impedance can be designed. The fourth prior art discloses a microstrip antenna that can be reduced in dimension as compared to any transmission lines which transmit wavelengths of high-frequency electromagnetic field, an intrinsic impedance uniquely designed to equal to the effect of negative refractivity, and a method for controlling the intrinsic impedance of the transmission line.

### PRIOR ART DOCUMENT

Patent Document 1: Unexamined Japanese Patent Applications Laid-Open No. 2001-053507
Patent Document 2: Unexamined Japanese Patent Applications Laid-Open No. 2005-277028
Non-Patent Document: C. Caloz et al., “Application of the transmission line theory of left-handed (LH) materials to the realization of a microstrip LH transmission line”, IEEE-APS International Symposium Digest, Vol. 2, pp. 412-415, June 2002.

### SUMMARY OF THE INVENTION

### Problem to be Solved by the Invention

In order to accomplish the model disclosed in the fourth prior art in a strip line for commercial use, it is necessary to provide the capacitors C2 in series in the strip cofactor 12. However, the fourth prior art fails to disclose a specific means to technically accomplish the strip conductor 12 having effective capacitance components serially distributed. The serial distribution of the effective capacitance components is possibly replaced with insertion of lumped constant capacitor elements, in which case an impedance discontinuity is generated at the junction of the capacitor elements. The impedance discontinuity results in signal reflection or loss, which contradicts the object of the fourth prior art. There is another alternative structure where portions corresponding to the inductors L2 are provided in the strip conductor 12, in which case the portions corresponding to the inductors L2 are provided in the strip conductor 12 in the form of strip-like stabs. However, it is difficult to form the strip-like stabs between gaps in the wiring layout of the strip conductor 12.

In the structure where the intrinsic impedance of the strip line changes at any intermediate position (see FIGS. 11 and 12), such an event as signal deterioration or distortion is unavoidable in any part where the intrinsic impedance changes.

The present invention was accomplished to solve the technical problems described so far, and provides a microstrip line configured to substantially equalize passing frequency characteristics in a broad band regardless of possible fluctuation of intrinsic impedance of the strip line.

### Means for Solving the Problem

A strip line according to the present invention comprises:

a dielectric board;

a strip conductor provided on the dielectric board; and

a conductor provided on a surface of the dielectric board and facing the strip conductor in a thickness direction of the dielectric board, wherein

a hole is formed in the conductor so as to penetrate therethrough along the thickness direction of the dielectric board.

### Effect of the Invention

The present invention can accomplish passing frequency characteristics which are substantially consistent. Though the intrinsic impedance is subject to change due to the structural characteristic of the strip line, passing frequency characteristics substantially consistent in a broad band can be obtained, which prevents a signal waveform from deteriorating.

### BRIEF DESCRIPTION OF THE DRAWINGS

FIG. 1A is a front view of a strip line according to an exemplary embodiment 1 of the present invention.

FIG. 1B is a rear view of the strip line illustrated in FIG. 1A.

FIG. 1C is a longitudinal sectional view of the illustration of FIG. 1A cut along F-F′.

FIG. 1D is a sectional view illustrating a first modified embodiment of the exemplary embodiment 1.

FIG. 1E is a plan view illustrating a second modified embodiment of the exemplary embodiment 1.

FIG. 1F is a plan view illustrating a third modified embodiment of the exemplary embodiment 1.

FIG. 1G is a plan view illustrating a fourth modified embodiment of the exemplary embodiment 1.

FIG. 1H is a plan view illustrating a fifth modified embodiment of the exemplary embodiment 1.

FIG. 1I is a plan view illustrating a sixth modified embodiment of the exemplary embodiment 1.

FIG. 2 is a circuit diagram of an equivalent circuit in the strip line illustrated in FIGS. 1A-1C.

FIG. 3 is a schematic illustration used to describe the flow of an induction current in a ground conductor of the strip line illustrated in FIGS. 1A-1C.

FIG. 4A is a front view illustrating a simulation model structurally characterized in that the paired strip lines illustrated in FIGS. 1A-1C face each other and a joint section is not provided with a ground conductor.

FIG. 4B is a rear view of the simulation model illustrated in FIG. 4A.

FIG. 5A is a graph illustrating passing characteristics in the case where holes 13 are not formed in a ground conductor 11 in the simulation model illustrated in FIGS. 4A-4B.

FIG. 5B is a graph illustrating passing characteristics of the simulation model illustrated in FIGS. 4A-4B.

FIG. 6 is a sectional view of a strip line according to an exemplary embodiment 2 of the present invention.

FIG. 7A is a plan view illustrating a strip line according to a first prior art.

FIG. 7B is a longitudinal sectional view of the illustration of FIG. 7A cut along D-D′.

FIG. 8 is a perspective view of the strip line illustrated in FIGS. 7A-7B.

FIG. 9A is a transverse sectional view of a strip line according to a second prior art.

FIG. 9B is a longitudinal sectional view of the illustration of FIG. 9A cut along A-A′.

FIG. 9C is a longitudinal sectional view of the illustration of FIG. 9A cut along B-B′.

FIG. 9D is a longitudinal sectional view of the illustration of FIG. 9A cut along C-C′.

FIG. 10 is a perspective view of a strip line according to a third prior art.

FIG. 11A is a front view of a microstrip line having a discontinuity structure.

FIG. 11B is a plan view of the microstrip line illustrated in FIG. 11A.

FIG. 11C is a longitudinal sectional view of the illustration of FIG. 11A cut along E-E′.

FIG. 11D is a side view of the microstrip line illustrated in FIG. 11A.

FIG. 12 is a perspective view of the strip line illustrated in FIG. 11A.

FIG. 13 is a circuit diagram of an equivalent circuit as a transmission line model based on the concept of high-frequency materials which is a design theory employed in a fourth prior art.

### EXEMPLARY EMBODIMENTS FOR CARRYING OUT THE INVENTION

Hereinafter, exemplary embodiments of the present invention are described in detail referring to the drawings. In the exemplary embodiments and prior art examples, the same reference symbols are used to describe structural elements similarly configured.

### Exemplary Embodiment 1

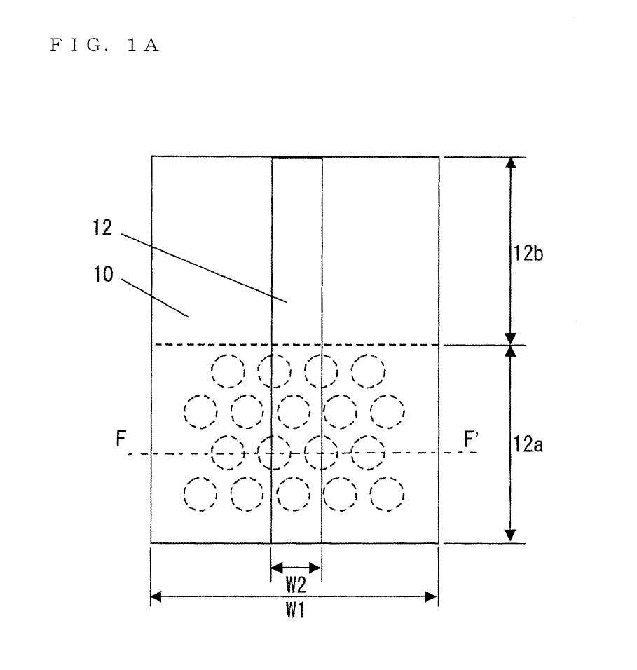

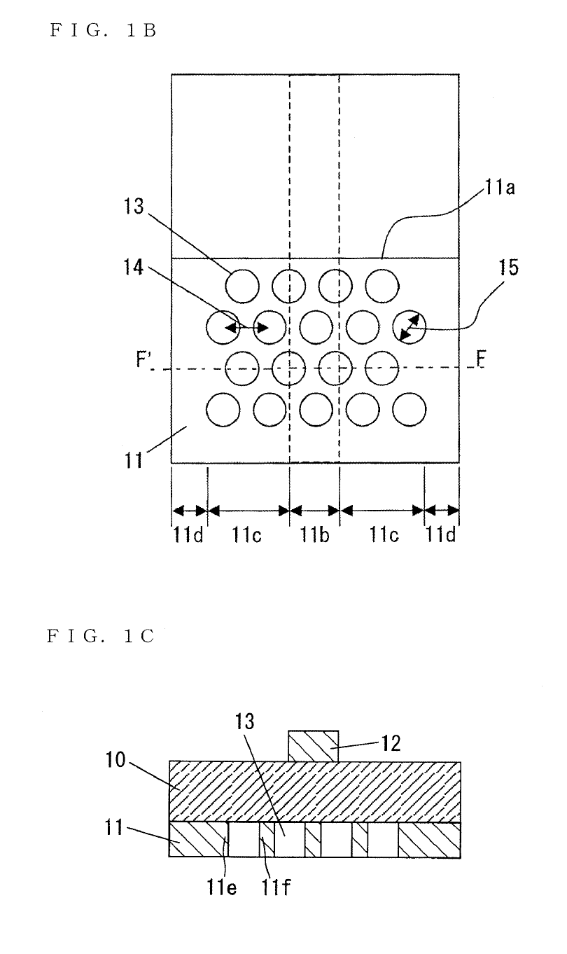

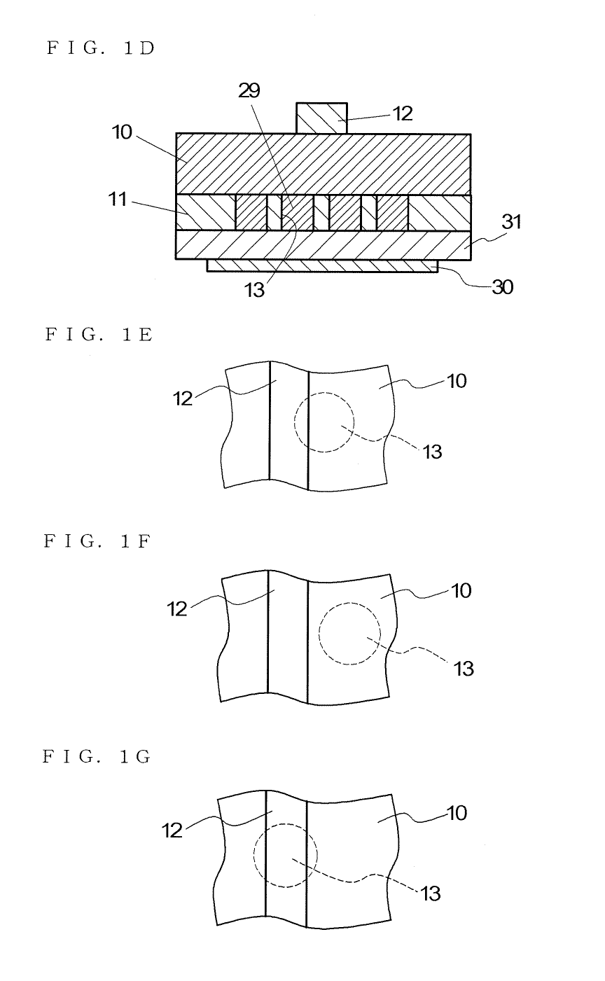

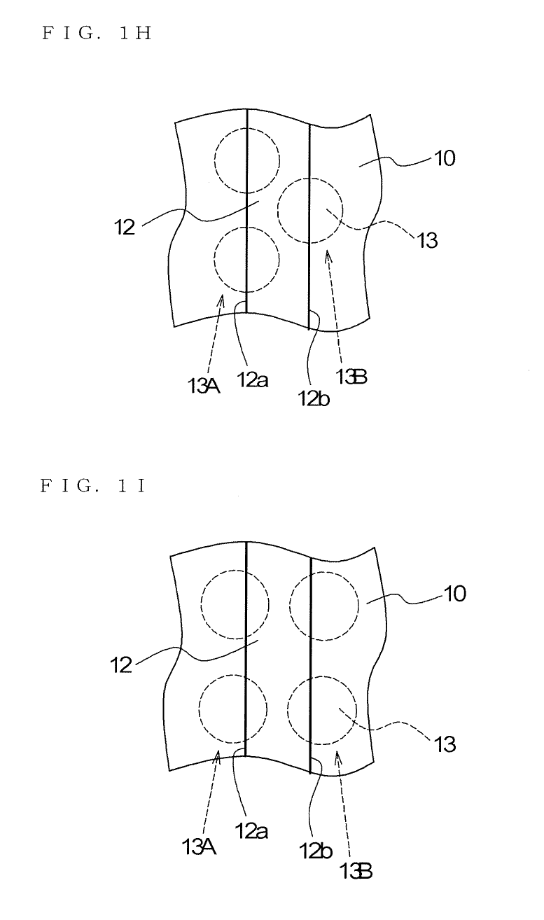

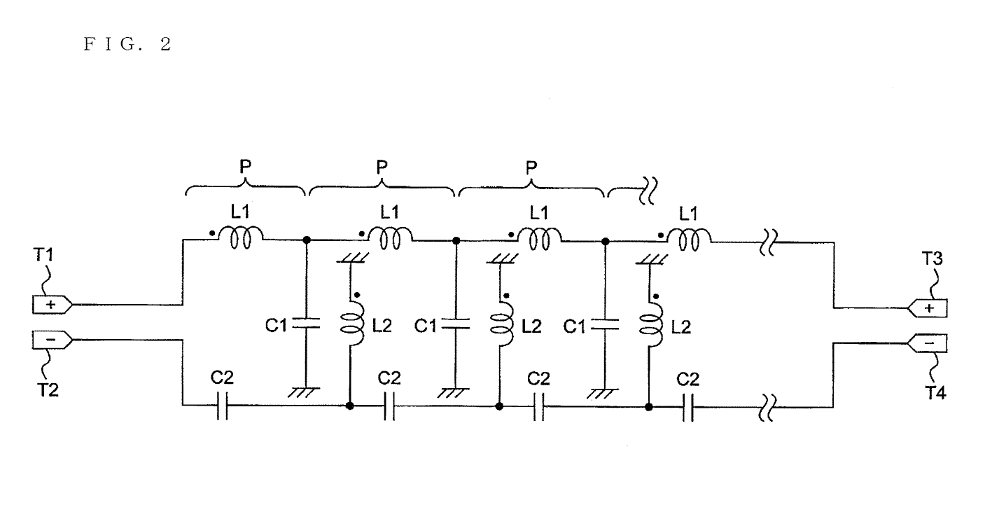

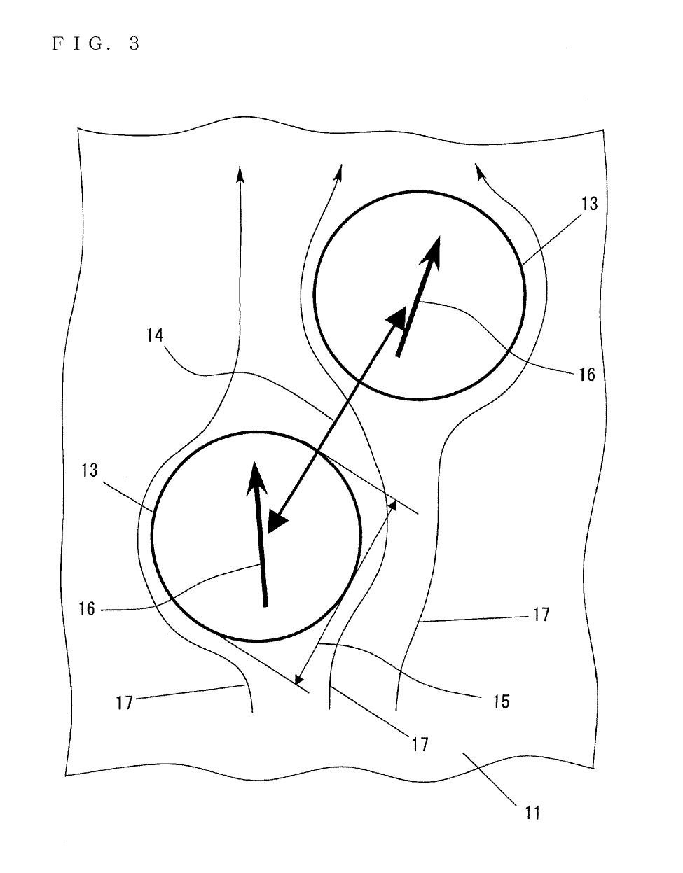

FIG. 1A is a front view of a strip line according to an exemplary embodiment 1 of the present invention. FIG. 1B is a rear view of the strip line illustrated in FIG. 1A. FIG. 1C is a longitudinal sectional view of the illustration of FIG. 1A cut along F-F′.

The strip line according to the present exemplary embodiment comprises a dielectric board 10, and a ground conductor 11 and a strip conductor 12 with the dielectric board 10 held therebetween. The ground conductor 11 provided in the strip line does not extend across an entire conductor area along a longitudinal direction of the strip conductor 12 (signal transmission direction). Accordingly, the strip conductor 12 comprises two conductor regions 12a and 12b along the longitudinal direction thereof (signal transmission direction). The conductor region 12a is provided with the ground conductor 11 at a position where the dielectric board 10 is interposed. The conductor region 12b is not provided with the ground conductor 11 at the position where the dielectric board 10 is interposed. The ground conductor 11 has marginal portions 11a positioned at intermediate positions in the longitudinal direction of the strip line (border between the portion where the ground conductor is formed and the portion where the ground conductor is not formed).

The present exemplary embodiment is technically advantageous in that the holes 13 are formed in the ground conductor 11. In the present exemplary embodiment, multiple holes 13 are preferably formed in order to maximize the effect of the present invention. However, just one hole 13 may be formed, in which case the effect of the present invention, though reduced to minimum, can still be obtained.

The holes 13 are formed so as to penetrate through the ground conductor 11 in the thickness direction thereof (in the same direction as the thickness direction of the dielectric board 10). In the present exemplary embodiment, the hole 13 has a circular shape. The hole 13 is preferably circularly formed, however, may have a shape other than the circular shape (for example, polygonal shape). The holes 13 are formed near the marginal portions 11a, and also in the conductor region of the ground conductor 11 described below.

A conductor width W1 of the ground conductor 11 is larger than a conductor width W2 of the strip conductor 12 (W1>W2). The ground conductor 11 includes a first conductor region 11b, a second conductor region 11c, and a third conductor region 11d along the width direction of the strip line. The first conductor region 11b faces the strip conductor 12. The second conductor region 11c is in proximity of the first conductor region 11b. The third conductor region 11d is in proximity of the second conductor region 11c but distant from the first conductor region 11b. The holes 13 are formed in the first conductor region 11b and the second conductor region 11c both but are not formed in the third conductor region 11d. Accordingly, the holes 13 are formed in the ground conductor 11 so that they can three-dimensionally intersect with the strip conductor 12 or be three-dimensionally in proximity of the strip conductor 12. The holes 13 are positioned so that a distance between the holes 13 adjacent to each other (distance between the centers of the holes) 14 is at most ½ of an effective wavelength λ of a transmitted signal. It is meant by the three-dimensional intersection with the strip conductor 12 that the holes 13 are really distant from one another in the thickness direction of the strip conductor 12 but appear to intersect with one another when viewed from the thickness direction of the strip conductor 12. It is meant by the three-dimensional proximity of the strip conductor 12 means that the holes 13 are really distant from one another in the thickness direction of the strip conductor 12 but appear to be in proximity of one another when viewed from the thickness direction of the strip conductor 12.

According to the present exemplary embodiment, the holes 13 are formed in the first conductor region 11b and the second conductor region 11c both. The present invention can exert its effect as far as the holes are formed in at least one of the first and second conductor regions 11b and 11c. According to the present exemplary embodiment, the distance 14 has an equal dimension in any of the holes 13. The present invention is not necessarily limited thereto, and the holes 13 may be formed so that the distance 14 is different from one hole to another. The hole 13 may be a blank cavity or filled with a dielectric member.

In the marginal portions 11a which are the border portions where the ground conductor 11 is absent, an intrinsic impedance changes between conductor portions in the ground conductor 11 distributed along the signal transmission direction of the strip conductor 12. In the present exemplary embodiment, the holes 13 are formed in proximity of the particular conductor portions (marginal portions 11a).

As illustrated in FIG. 1D, the holes 13 may be filled with a dielectric member 29, in which case upper portions thereof are coated with a coating conductor 30, and any space between the coating conductor 30 and the holes 13 is filled with a dielectric member 31.

The multiple holes 13 may be formed longitudinally in a multilayered shape, wherein an electric field induced by the multilayered holes leaks to the rear surface of the dielectric board 10 and generates an induction field near upper ends of the multilayered holes (near the surface), thus more effectively exerting an electric field polarizing effect. However, a simulation test proved that the electric field polarizing effect in the multilayered structure was not very different to the electric field polarizing effect in the mono-hole structure. However, another simulation test conformed that the hole structure provided with the coating conductor 30 illustrated in FIG. 1D exerted the electric field polarizing effect larger than in the mono-hole structure and the multilayered structure. The structure is thus advantageous probably because the coating conductor 30 makes the electric field leaking from the holes 13 more intensely exert a coupling effect than in any other hole structures. As a result, the motion of the electric field components induced by the holes 13 can be more effectively controlled, which more effectively controls dielectric polarization. Speaking of opposed conductors according to the present invention including the hole formation region of the ground conductor 11 and the coating conductor 30 (hereinafter, called first opposed conductors), and opposed conductors in the before-mentioned example including the hole formation region of the ground conductor 11 and the multiple-hole conductor (hereinafter, called second opposed conductors), an electrostatic capacity formed between the first opposed conductors is larger than an electrostatic capacity formed between the second opposed conductors, and an electric coupling amount generated in the first opposed conductors through the electrostatic capacity is larger than an electric coupling amount generated in the second opposed conductors through the electrostatic capacity. This is likely the reason why the hole structure illustrated in FIG. 1D is more advantageous.

Next, the three-dimensional intersection between the strip conductor 12 and the holes 13 is described. The electric field induced by the holes 13 is generated by a current flowing in the ground conductor 11 as enantiomorphic current of a current flowing in the strip conductor 12. In the strip conductor 12, the current flow generally converges on the marginal portions of the signal line. In the ground conductor 11, therefore, the enantiomorphic current is likely to converge on the portions facing the marginal portions of the strip conductor 12 (both ends of the strip conductor 12 along a direction orthogonal to the signal transmission direction of the strip line). In light of the characteristic of the enantiomorphic current, the electric field polarizing effect is larger in the structure illustrated in FIG. 1E where the holes 13 three-dimensionally intersect with the strip conductor 12 on one of its marginal portions alone than in the structure illustrated in FIG. 1F where the holes 13 three-dimensionally intersect with the strip conductor 12 away from the marginal portions thereof. When the holes three-dimensionally intersect with the strip conductor 12 on the marginal portions of the strip conductor 12 as illustrated in FIG. 1G, the induction current is larger than in the illustration of FIG. 1E. However, the induced electric field generated in the region provided with the holes 13 no longer rotates (though the polarized electric field rotates), and the effect of the present invention cannot be obtained. Therefore, the illustration of FIG. 1E is considered most suitable for the effect of the present invention.

Next, periodical patterns of the holes 13 are described. When the holes 13 three-dimensionally intersect with the marginal portions of the strip conductor 12, the holes 13 may be asymmetrical to the strip conductor 12 as illustrated in FIG. 1H, or may be symmetrical to the strip conductor 12 as illustrated in FIG. 1I. The asymmetrical structure is described below. The plurality of holes 13 includes a first group of holes 13A and a first group of holes 13B. The first group of holes 13A includes at least one hole 13 positioned along the signal transmission direction so as to overlap with one of the marginal portions 12a of the strip conductor 12 along the direction orthogonal to the signal transmission direction of the strip line. The second group of holes 13B includes at least one hole 13 positioned along the signal transmission direction so as to overlap with the other marginal portion 12a of the strip conductor 12. The hole 13 constituting the first group of holes 13A and the hole 13 constituting the second group of holes 13B are not positioned equally along the signal transmission direction but are alternately positioned along the signal transmission direction. This is the structure where the holes 13 are asymmetrical to the strip conductor 12. When the hole 13 constituting the first group of holes 13A and the hole 13 constituting the second group of holes 13B are positioned equally in the width direction of the strip conductor 12, the holes 13 are symmetrical to the strip conductor 12.

There is hardly a difference between the electric field polarizing effects obtained in these two structures. However, the holes 13 can be more densely positioned along the signal line direction in the structure of FIG. 1H (asymmetry) than in the structure of FIG. 1I (symmetry). Therefore, it is likely that the electric field polarizing effect in the structure of FIG. 1H (asymmetry) is superior to the other as far as the signal lines in the two structures have an equal length.

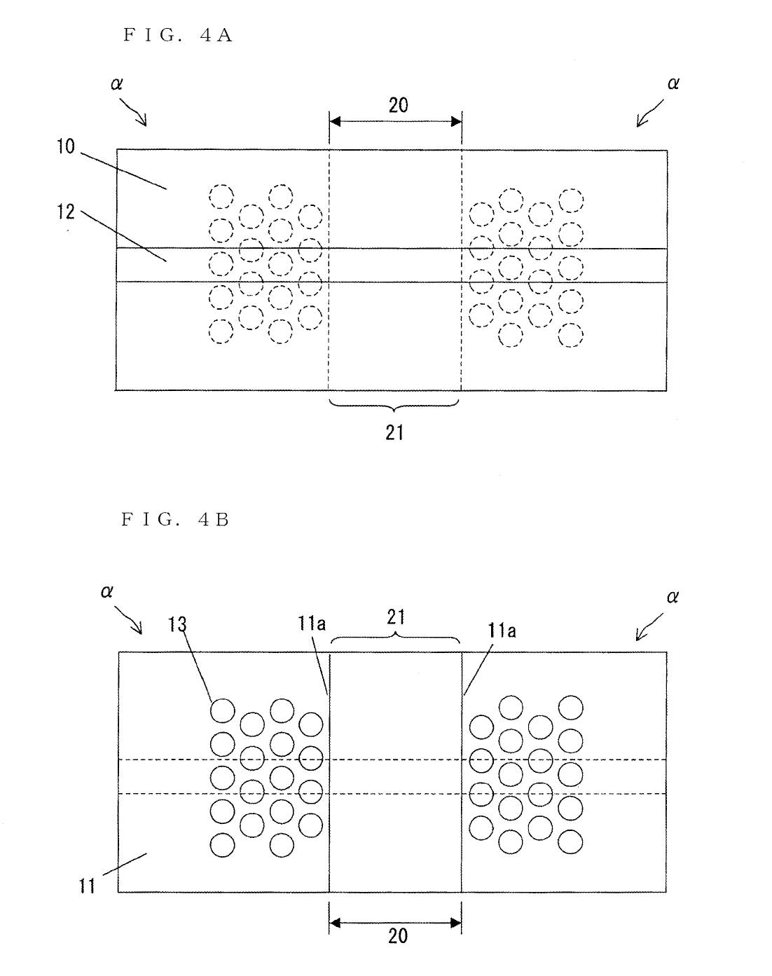

The effect of the strip line according to the present exemplary embodiment thus technically characterized is described referring to FIGS. 2 and 3. FIG. 2 is a circuit diagram of an equivalent circuit in the strip line according to the present exemplary embodiment (FIGS. 1A-1C). FIG. 3 is a schematic illustration used to describe the flow of induction current in the ground conductor 11 of the strip line according to the present exemplary embodiment (FIGS. 1A-1C).

In the equivalent circuit illustrated in FIG. 2, an inductor L1 represents an inductance of the strip conductor 12, and a capacitor C1 represents a capacitance between the strip conductor 12 and the ground conductor 11. A capacitor C2 represents a capacitance obtained in the holes 13 formed in the ground conductor 11, and an inductor L2 represents an inductance generated when the induction current flowing in the ground conductor 11 flows in the ground conductor 11 having the holes 13. The capacitor C1 includes a dielectric member (including air) in the hole 13, and conductor hole edges 11e and 11f facing each other with the hole 13 interposed therebetween. The equivalent circuit is expressed in the form of a distributed constant circuit where sectional circuits P are connected in tandem in a plurality of stages.

FIG. 3 illustrates a distribution of an induction current 17 generated in the ground conductor 11 provided with the holes 13 each having a diameter 15 and an inter-hole distance 14. The induction current 17 is generated in the ground conductor 11 by the signal current flowing in the strip conductor 12, and an electric field 16 is generated in the hole 13 by the induction current 17. The direction and dimension of the electric field 16 are decided by the intensity and direction of the current flowing around the hole 13. The electric fields 16 generated in the adjacent holes 13 are affected by an interaction generated therebetween. When the diameter 15 and the inter-hole distance 14 of each hole 13 are adjusted, the capacitor 2 (capacitance) can be adjusted. The interaction between the electric fields 16 can be described by using a model in which the electric fields 16 generated in the holes 13 are regarded as electric dipoles having dimensions and directions affecting each other. The inter-hole distance 14 is preferably ½ of the wavelength of the signal transmitted through the strip conductor 12. Then, passing frequency characteristics substantially consistent in a broad range can be obtained so that the signal waveform can be prevented from deteriorating.

The inductance L2 is decided by the distribution of the induction current 17. Therefore, when the diameter 15 and the inter-hole distance 14 of the hole 13 are relatively changed, the inductor (inductance) can be adjusted. When the number of the holes 13 in the longitudinal direction of the strip line is changed, the number of stages of the sectional circuits P in the equivalent circuit illustrated in FIG. 2 can be adjusted.

It is clear from the equivalent circuit illustrated in FIG. 2 that, in the metamaterial transmission line model of the fourth prior art (Non-Patent Document 1), the holes 13 formed in the ground conductor 11 can replace the inductances L2 and the capacitances C2 which are separately provided in the signal line as electronic components. The present invention thus technically characterized can reduce the number of structural elements. When the circuit configuration (in particular, inductor L2, capacitor C2) of the sectional circuit P in each equivalent circuit is optimally designed, frequency distribution of the intrinsic impedance in the whole strip line, including the portions where the intrinsic impedance changes (marginal portions 11a), can be equalized in a broad band.

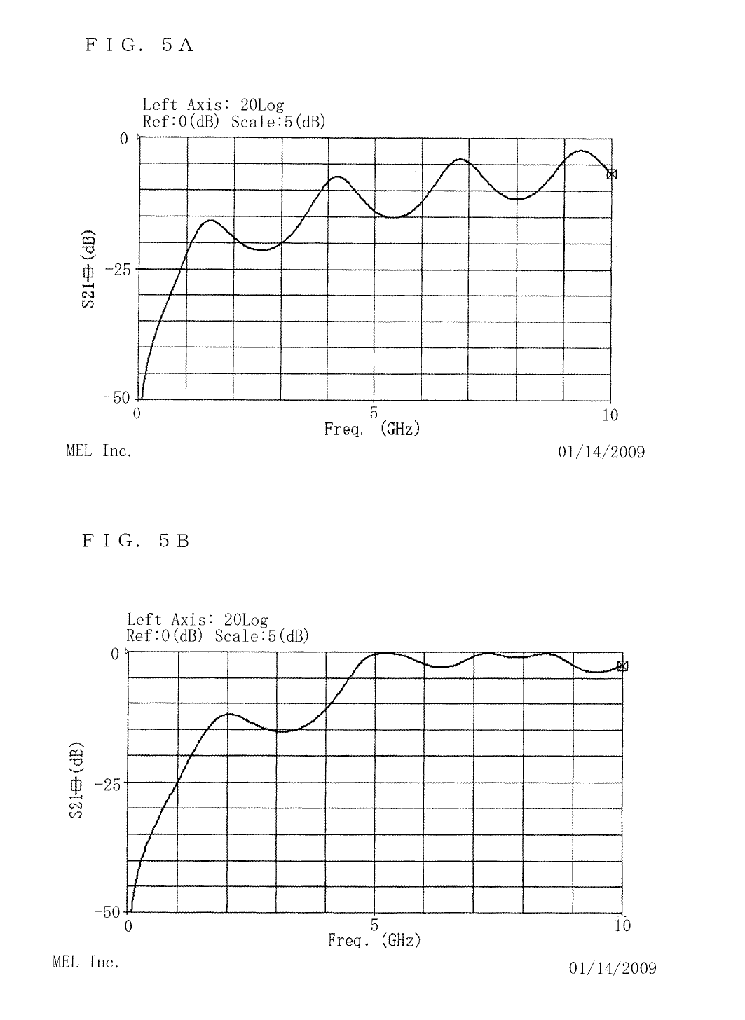

The effect of the present exemplary embodiment is described referring to FIGS. 4A and 4B. These drawings illustrate a simulation model in which structures a of the strip line illustrated in FIGS. 1A-1C face each other with an interval 20 therebetween in the longitudinal direction of the strip line. FIG. 4A is a front view of the simulation model, and FIG. 4B is a rear view of the simulation model. The structures α, though distant from each other with the interval 20 therebetween, are coupled with each other by a coupler 21 having a length equal to the interval 20. In the coupler 20, the dielectric board 10 and the strip conductor 12 are shared by the structures α.

In the simulation model illustrated in FIGS. 4A and 4B, the holes 13 are formed near the marginal portions 11a which are the border portions where the ground conductor 11 is absent (portions where the intrinsic impedance changes) in the structures α.

FIGS. 5A and 5B are graphs illustrating the passing characteristics in the simulation model. FIG. 5A shows the passing characteristics of the strip line where the holes 13 are not formed in the ground conductor 11 (prior art). FIG. 5B shows the passing characteristics of the simulation model illustrated in FIGS. 4A and 4B. In the simulation model wherein the holes 13 are not formed in the ground conductor 11, the passing characteristics fluctuate by at least about 10 dB in a broad band, therefore, the square wave of a transmitted signal is distorted. It is confirmed from the simulation model wherein the holes 13 are formed in the ground conductor 11 (present invention) that the passing characteristics show such an improvement as the fluctuation of at most about 3 dB extensively in a band of at least 5 GHz.

The present invention can successfully equalize the passing characteristics in a broad band in the case of the microstrip line where the intrinsic impedance is discontinuous, thereby accomplishing the strip line with less distortion in the signal waveform.

In the exemplary embodiment described so far, the hole 13 is a blank cavity. The hole 13 may be filled with a dielectric member made of the same material as the dielectric board 10 or a dielectric member made of a different material. When the holes 13 are filled with the dielectric member, the capacitance of the capacitor C2 in the equivalent circuit illustrated in FIG. 2 is practically changed.

### Exemplary Embodiment 2

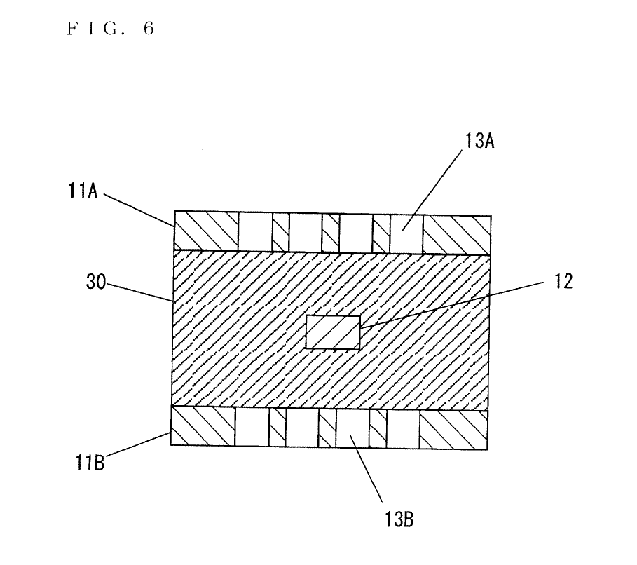

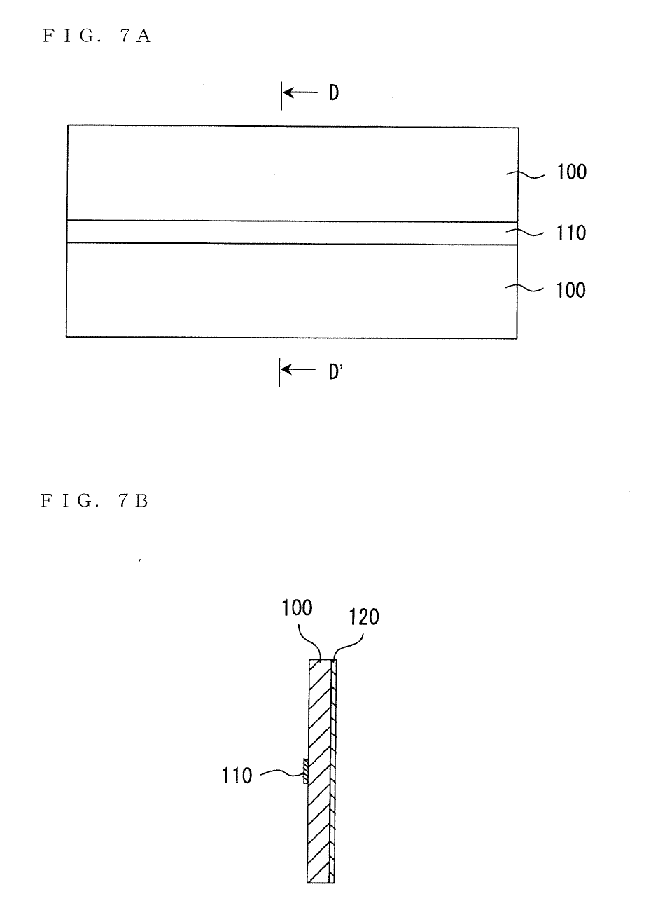

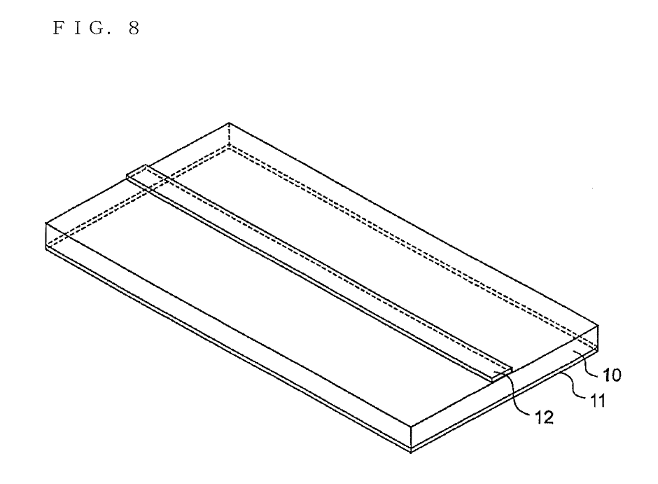

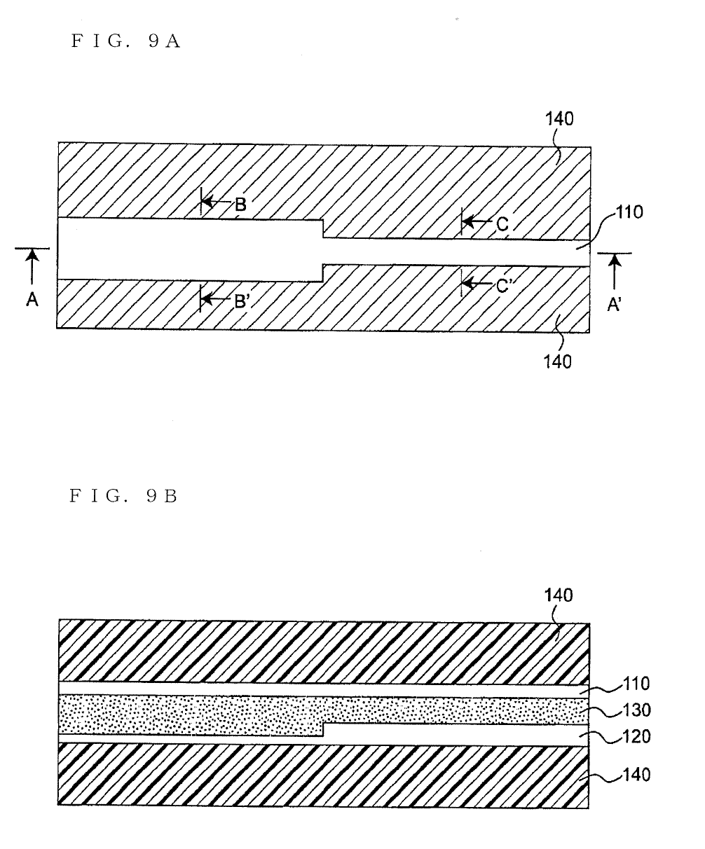

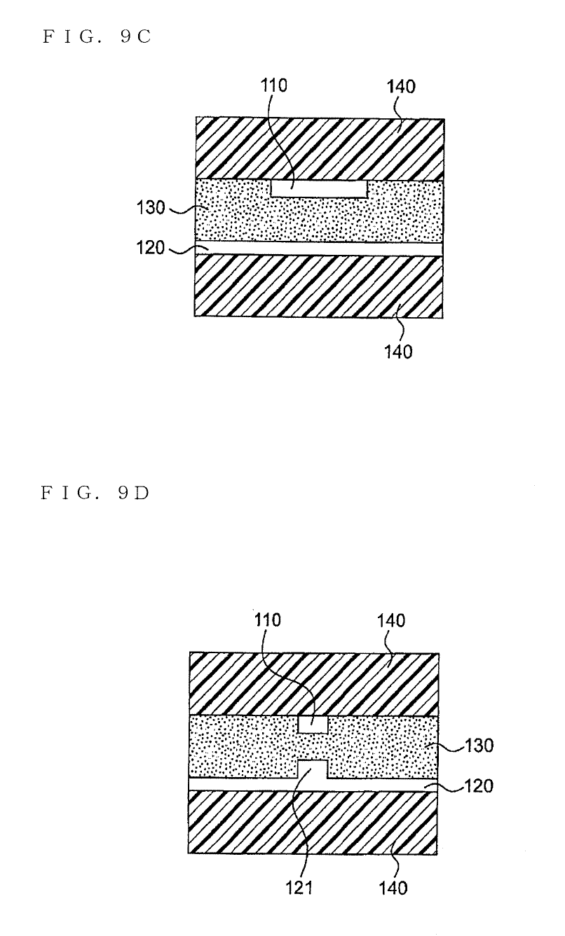

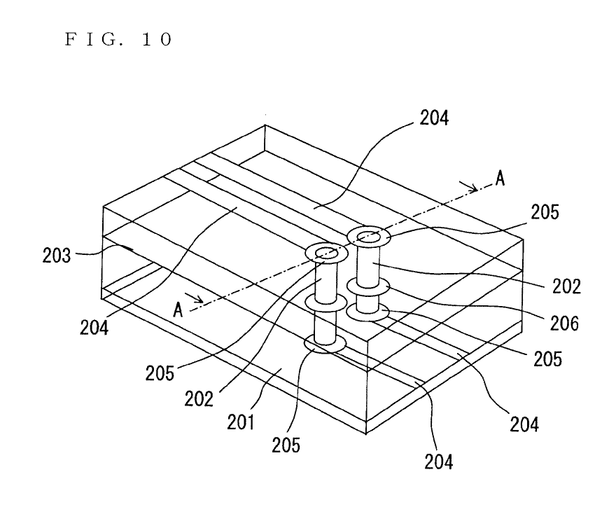

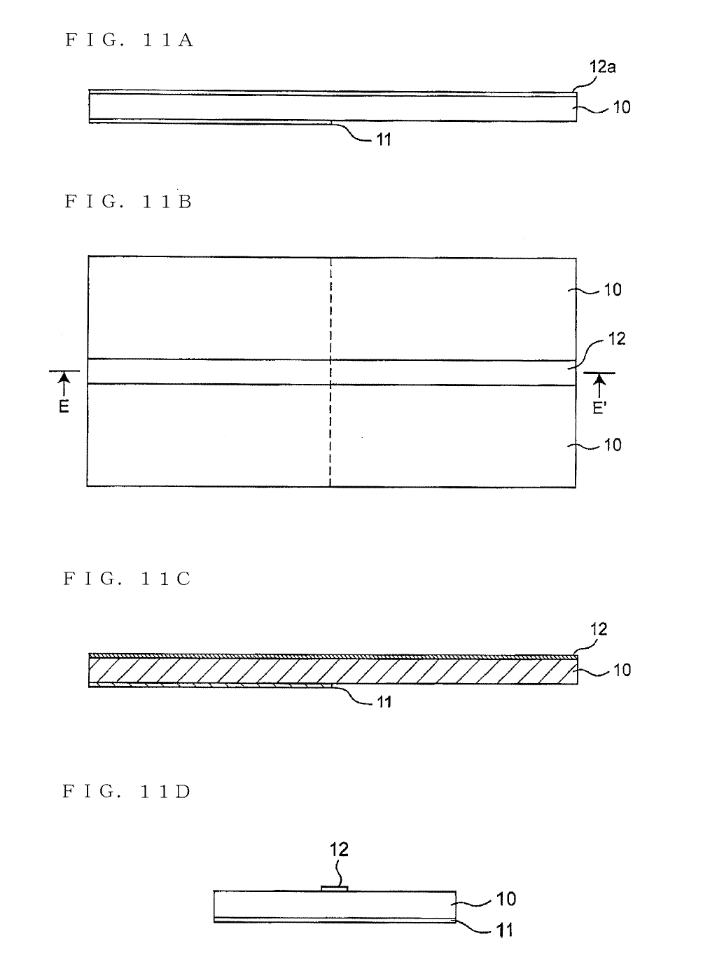

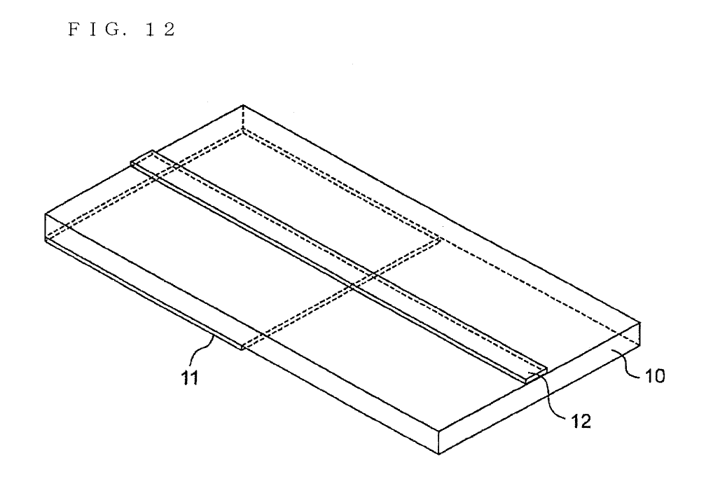

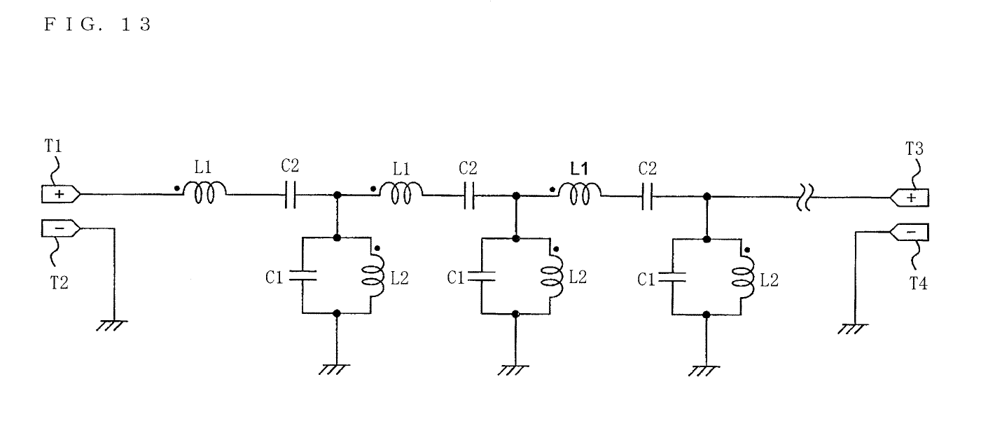

FIG. 6 is a sectional view of a strip line according to an exemplary embodiment 2 of the present invention. In the present exemplary embodiment, two strip lines according to the exemplary embodiment 1 are mounted on a dielectric board. The strip conductor 12 is provided inside a dielectric board 30, and ground conductors 11A and 11B are provided on both surfaces of the dielectric board 30. The dielectric board 30 is provided with two strip lines which share the strip line 12. Then, the present exemplary embodiment provides holes 13A and 13B respectively in the ground conductors 11A and 11B mounted on the both surfaces of the dielectric board 30.

According to the exemplary embodiment 2 thus technically characterized, the structure according to the exemplary embodiment 1 is multilayered, and an effect similar to that of the exemplary embodiment 1 can be obtained in the multilayered structure. In the exemplary embodiment 2, the holes 13A and 13B may be hollow or filled with a dielectric material. The holes 13A and 13B may be filled with a dielectric member made of the same material as the dielectric board 30 or a dielectric member made of a different material. In the exemplary embodiment 2, the holes 13A formed in the ground conductor 11A and the holes 13B formed in the ground conductor 11B may three-dimensionally overlap with each other (overlap with each other when viewed from the thickness direction of the dielectric board) or may not overlap at all (no overlap when viewed from the thickness direction of the dielectric board). When these holes 13A and 13B are formed so that they do not three-dimensionally overlap with each another, the passing frequency characteristics substantially consistent in a broad band can be more reliably obtained, and the signal waveform deterioration is less likely.

### INDUSTRIAL APPLICABILITY

When the present invention is applied to a strip line or a microstrip line used in a digital circuit or a substrate, distortion of a digital signal waveform can be lessened to accomplish a high-speed signal transmission. Further, the present invention which accomplishes the passing frequency characteristics substantially consistent in a broad band can provide a transmission line for a high-frequency circuit with less waveform distortion.

### DESCRIPTION OF REFERENCE SYMBOLS

10, 30 dielectric board
11, 11A, 11B ground conductor
11a marginal portion of ground conductor
12 strip conductor
13, 13A, 13B hole
14 inter-hole distance
15 diameter of hole
16 electric field
17 induction current

What is claimed is:

1. A strip line comprising:
a dielectric board;
a strip conductor provided on the dielectric board; and
a conductor provided on a surface of the dielectric board and facing the strip conductor in a thickness direction of the dielectric board, wherein
a hole is formed in the conductor so as to penetrate therethrough along the thickness direction of the dielectric board.

2. The strip line as claimed in claim 1, wherein
the conductor is a ground conductor of the strip line.

3. The strip line as claimed in claim 1, wherein
a width of the conductor is larger than a width of the strip conductor,
the conductor has a first conductor region facing the strip line, and
the hole is provided in at least the first conductor region.

4. The strip line as claimed in claim 1, wherein
a width of the conductor is larger than a width of the strip conductor,
the conductor has a first conductor region facing the strip line, a second conductor region in proximity of the first conductor region along a width direction of the conductor, and a third conductor region in proximity of the second conductor region along the width direction of the conductor and distant from the first conductor region, and
the hole is provided in at least one of the first conductor region and the second conductor region.

5. The strip line as claimed in claim 4, wherein
the hole is provided in both of the first conductor region and the second conductor region.

6. The strip line as claimed in claim 1, wherein
the hole is filled with a dielectric member.

7. The strip line as claimed in claim 1, wherein
the hole is provided in an arbitrary conductor portion of the conductor where an intrinsic impedance changes as compared to another conductor region among conductor regions distributed along a signal transmission direction of the strip line.

8. The strip line as claimed in claim 7, wherein
the conductor is a ground conductor having a length in the signal transmission direction smaller than a length of the strip conductor, and
the arbitrary conductor portion is a marginal portion of the ground conductor in the signal transmission direction.

9. The strip line as claimed in claim 1, wherein
the strip conductor is provided inside the dielectric board, and
the conductor is provided on both surfaces of the dielectric board and faces the strip conductor with the dielectric board interposed therebetween, and
the hole is provided in both of the conductors.

10. The strip line as claimed in claim 9, wherein
the hole provided in the conductor on one of the surfaces of the dielectric board and the hole provided in the other surface are formed at such positions that the holes do not overlap with each other when viewed from the thickness direction of the dielectric board.

11. The strip line as claimed in claim 1, comprising:
an inductor generated by an induction current flowing in the conductor when a signal is transmitted through the strip conductor; and
a capacitor including a dielectric member inside the hole and conductor hole edges facing each other with the hole interposed therebetween.

12. The strip line as claimed in claim 11, wherein
a plurality of the holes are provided, and
a diameter of each of the holes and a distance between the holes adjacent to each other are set based on electric characteristics demanded for the inductor and the capacitor.

13. The strip line as claimed in claim 1, wherein
the distance between the holes adjacent to each other is at most ½ of a wavelength of a signal transmitted through the strip conductor.

14. The strip line as claimed in claim 1, further comprising a coating conductor and a dielectric member, wherein
the coating conductor is provided at a position in an upper direction of a portion of the conductor where the hole is formed, and
the dielectric member is placed between the coating conductor and the conductor.

15. The strip line as claimed in claim 1, wherein
the hole is provided at positions overlapping with each other when viewed from the thickness direction of the dielectric board in one of marginal portions of the strip conductor along a direction orthogonal to a signal transmission direction of the strip line.

16. The strip line as claimed in claim 1, wherein
a plurality of the holes are provided, and
the plurality of holes includes:
a first group of holes including at least the hole provided along the signal transmission direction so as to overlap with one of marginal portions of the strip conductor along a direction orthogonal to a signal transmission direction of the strip line when viewed from the thickness direction of the dielectric board; and
a second group of holes including at least the hole provided along the signal transmission direction so as to overlap with the other marginal portion when viewed from the thickness direction of the dielectric board, and
the hole constituting the first group of holes and the hole constituting the second group of holes are not provided at equal positions along the signal transmission direction but are provided alternately along the signal transmission direction.
